(19) United States
(12) Patent Application Publication
(10) Pub. No.: US 2019/0084187 A1
(43) Pub. Date: Mar. 21, 2019

(54) POLISHING PAD MATERIAL MELTING DEVICE

(71) Applicant: NITTA HAAS INCORPORATED, Osaka (JP)

(72) Inventors: Katsumi KAWASE, Mie (JP); Yoshitane SHIGETA, Kyoto (JP); Masahito YAMAKOSHI, Mie (JP)

(21) Appl. No.: 15/742,993

(22) PCT Filed: Jul. 8, 2016
(86) PCT No.: PCT/JP2016/070297

§ 371 Date: Jan. 9, 2018

(30) Foreign Application Priority Data
Jul. 10, 2015 (JP) 2015-138948

(51) Int. Cl. B29B 13/10; B29B 13/02

(52) U.S. Cl. CPC B29B 13/10; B24D 18/0009; B29B 13/022

(57) ABSTRACT

Provided is a polishing pad material melting device including: a melting unit configured to melt a solid material; a flow path through which the material melted in the melting unit is circulated; and a filter unit fluidically connected to the flow path and including a filter unit body configured to filter the material melted in the melting unit, wherein the flow path includes a circulation path through which the material melted by the melting unit is circulated, and the filter unit is fluidically connected to the circulation path.

### CROSS-REFERENCE TO RELATED APPLICATION

This application claims priority to Japanese Patent Application No. 2015-138948, the disclosure of which is incorporated herein by reference in its entirety.

### FIELD

The present invention relates to a polishing pad material melting device configured to melt a material for producing polishing pads.

### BACKGROUND

Conventionally, polishing pads are produced by curing a mixed solution obtained by mixing various liquid materials together (for example, see Patent Literature 1). Therefore, for producing polishing pads, a polishing pad material melting device (which will be hereinafter referred to as a melting device) configured to melt solid materials is used.

The melting device, for example, includes an inlet into which a solid material is put, a melting unit configured to melt the solid material put into the inlet, and a flow path that allows the material melted by the melting unit to be circulated therethrough and is configured to send the melted material to the outside of the melting unit.

In such a melting device, the solid material put into the inlet is melted by the melting unit to be changed into liquid state, and the material changed into liquid state is sent out via the flow path as a polishing pad material.

However, in the conventional melting device, the material sent out from the melting unit may possibly contain solid matter such as foreign matter that is contained in the solid material put into the inlet and unmelted material, and therefore polishing pads produced may possibly contain such solid matter, in some cases. Therefore, the polishing pads produced may easily cause polishing scratch on polishing targets in some cases.

In the conventional melting device, solid materials that are put into the inlet individually have different properties (such as size and component ratio), and therefore the non-uniform melting or the non-uniform mixing of the material discharged from the outlet may possibly take place depending on the solid material put therein in some cases. Therefore, the properties of polishing pads produced may possibly vary in some cases.

In this way, the quality of the material melted in the conventional melting device varies, as a result of which the quality of polishing pads produced may vary in some cases.

### CITATION LIST

### Patent Literature

Patent Literature 1: JP 2008-137355 A

### SUMMARY

### Technical Problem

In view of such circumstances, it is therefore an object of the present invention to provide a polishing pad material melting device that stabilizes the quality of the melted material.

### Solution to Problem

A polishing pad material melting device according to the present invention includes: a melting unit configured to melt a solid material; a flow path through which the material melted in the melting unit is circulated; and a filter unit fluidically connected to the flow path and including a filter unit body configured to filter the material melted in the melting unit, wherein the flow path includes a circulation path through which the material melted by the melting unit is circulated, and the filter unit is fluidically connected to the circulation path.

According to another embodiment of the present invention, a polishing pad material purification system may have a configuration in which the filter unit body includes a plurality of filter media each having a different mesh roughness and stacked on each other, and the plurality of filter media having rougher meshes are arranged more on the upstream side in the direction in which the melted material flows.

### BRIEF DESCRIPTION OF DRAWINGS

FIG. 1 is a schematic view of a material purification system including a polishing pad material melting device according to an embodiment of the present invention.

FIG. 2 is a schematic view of the melting device according to the aforementioned embodiment.

FIG. 3 is an explanatory diagram of the melting device according to the aforementioned embodiment, showing the state where the melting device melts a solid material put therein.

FIG. 4 is an explanatory diagram of the melting device according to the aforementioned embodiment, showing the state where the melting device sends out the melted material.

### DESCRIPTION OF EMBODIMENTS

Hereinafter, an embodiment of the present invention will be described with reference to the attached drawings.

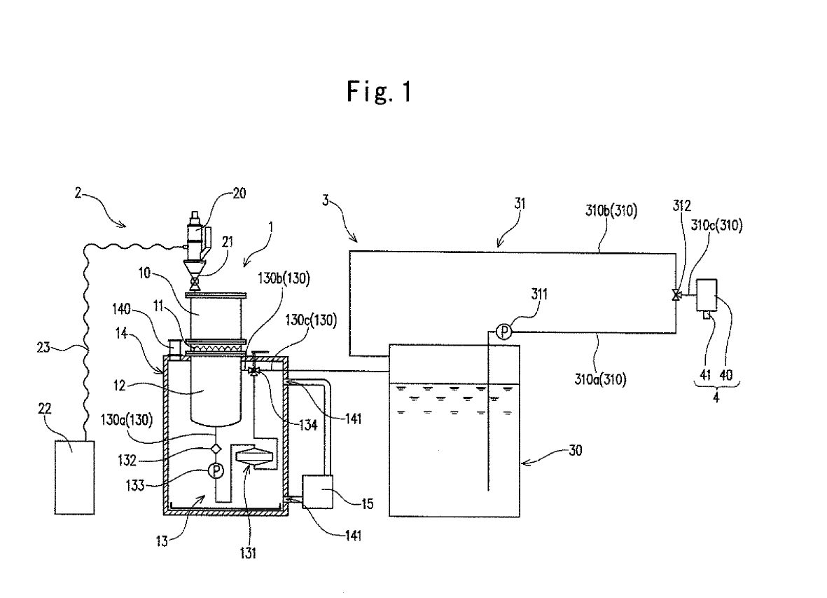

A melting device according to this embodiment purifies a liquid material by melting a solid material put therein. As shown in FIG. 1, in this embodiment, the following description will be given on the premise that a melting device 1 is used as a part of a material purification system configured to purify a polishing pad material (which will be hereinafter referred to as a material purification system).

A more specific description will be given. The material purification system according to this embodiment includes the melting device 1 configured to purify a liquid material by melting a solid material put therein, an inlet device 2 configured to put the solid material into the melting device 1, and a homogenizer 3 configured to homogenize the melted material by stirring. Further, in the material purification system, an outlet device 4 configured to output the material homogenized by the homogenizer 3 is connected to the homogenizer 3. In this embodiment, the following description may be given while the material in solid state is referred to as solid material, and the material melted and changed from solid state to liquid state is referred to as liquid material.

First, the inlet device 2 will be described. The inlet device 2 includes a hopper 20 having a supply port through which the solid material is supplied and a discharge port through which the supplied solid material is discharged to the melting device 1 (an inlet of the melting device 1, which will be described below). Further, the inlet device 2 includes an on-off valve 21 arranged between the discharge port of the hopper 20 and the melting device 1. The inlet device 2 includes a storage tank 22 that allows the solid material to be stored therein and is connected to the supply port of the hopper 20 via a pipe member 23.

As described above, the on-off valve 21 is arranged between the discharge port of the hopper 20 and the melting device 1 in the inlet device 2. Therefore, in the inlet device 2, when the on-off valve 21 is opened, the input of the solid material from the hopper 20 into the melting device 1 is allowed, and when the on-off valve 21 is closed, the input of the solid material from the hopper 20 into the melting device 1 is restricted.

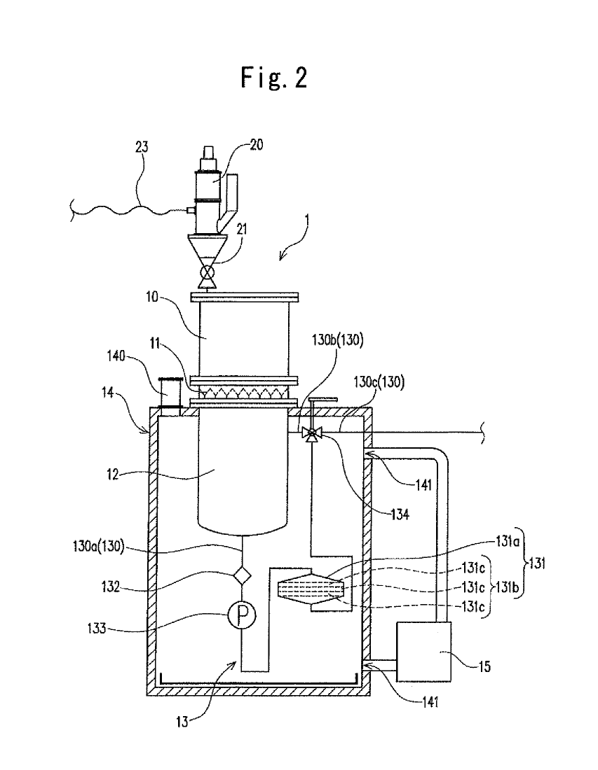

As shown in FIG. 2, the melting device 1 includes an inlet 10 into which the solid material is put, and a melting unit 11 configured to melt the solid material put into the inlet 10. The melting device 1 includes a storage 12 configured to store the material melted by the melting unit 11. The melting device 1 includes a circulation system 13 configured to circulate the material melted by the melting unit 11 therethrough. Further, the melting device 1 includes a housing 14 in which the storage 12 and the circulation system 13 are arranged, and a heat retaining unit 15 configured to maintain the temperature inside the housing 14 at a specific temperature (temperature at which the melted material can be maintained in the liquid state).

The inlet 10 is of a cylindrical shape. One end in the center line direction of the inlet 10 is connected to the melting unit 11. Therefore, the solid material discharged from the inside of the hopper 20 via the on-off valve 21 is put into the inlet 10 according to this embodiment through the other end in the center line direction of the inlet 10.

A heat-meltable material is put into the inlet 10. For example, 4,4′-methylenebis(o-chloroaniline) (so-called MOCA) is put into the inlet 10 according to this embodiment as a material. A material containing MOCA or materials such as 4,4′-diaminodiphenyl methane, m-phenylenediamine, diethylene toluenediamine (so-called DETDA), and trimethylolpropane may be put into the inlet 10.

The melting unit 11 changes the solid material put into the inlet 10 from solid state to liquid state by heating the solid material. In the storage 12, the material changed from solid state to liquid state by the melting unit 11 is stored.

The circulation system 13 includes a flow path 130 fluidically connected to the storage 12. The circulation system 13 includes a filter unit 131 connected to the flow path 130 and configured to filter the material circulated through the flow path 130. The circulation system 13 further includes a strainer 132 connected to the flow path 130, and a delivery pump 133 connected to the flow path 130 and arranged downstream of the strainer 132.

The flow path 130 includes a delivery pipe 130a into which the liquid material inside the storage 12 flows, and a connection pipe 130b fluidically connected to each of the delivery pipe 130a and the storage 12. The flow path 130 further includes a supply pipe 130c fluidically connected to the delivery pipe 130a and configured to send out the liquid material to the outside (in this embodiment, the homogenizer 3).

The circulation system 13 according to this embodiment further includes a supply valve 134 that can be switched between the state where the delivery pipe 130a and the connection pipe 130b communicate with each other and the state where the delivery pipe 130a and the supply pipe 130c communicate with each other.

Therefore, when the supply valve 134 is switched to the state where the delivery pipe 130a and the connection pipe 130b communicate with each other, the delivery pipe 130a, the connection pipe 130b, and the storage 12 communicate with one another, thereby forming a melting path that serves as a circulation path through which the liquid material is circulated in the melting device 1. Then, the circulation of the liquid material from the delivery pipe 130a to the supply pipe 130c (that is, supply of the liquid material to the homogenizer 3) is restricted.

Meanwhile, when the supply valve 134 is switched to the state where the delivery pipe 130a and the supply pipe 130c communicate with each other, the circulation of the liquid material from the delivery pipe 130a to the supply pipe 130c (supply of the liquid material to the homogenizer 3) is allowed. Then, the circulation of the liquid material from the delivery pipe 130a to the connection pipe 130b is restricted.

The filter unit 131 includes a holder 131a in which the liquid material is circulated, and a filter unit body 131b arranged in the holder 131a. The filter unit 131 is arranged downstream of the delivery pump 133 in the flow path 130 (the delivery pipe 130a).

The holder 131a includes an inflow port through which the liquid material in the flow path 130 flows therein, and an outflow port through which the liquid material thereinside is sent to the flow path 130.

The filter unit body 131b is arranged between the inflow port and the outflow port. The filter unit body 131b includes a plurality of filter media 131c each having a different mesh roughness (pore size) and stacked on each other. Each filter medium 131c has a flat plate shape.

The mesh of each filter medium 131c is finer than the mesh of the strainer 132. Further, the plurality of filter media 131c having rougher meshes are arranged at positions closer to the inflow port (that is, more on the upstream side in the direction in which the melted material flows). Non-woven fabric, filter paper, or the like is employed for the filter media 131c.

The strainer 132 is, for example, constituted by a mesh made of metal or a perforated metal.

In the circulation system 13 according to this embodiment, a gear pump is employed as the delivery pump 133. The delivery pump 133 is not limited to the gear pump as long as it can circulate the material stored in the storage 12 through the circulation system 13.

The housing 14 includes an exhaust port 140 passing therethrough between the inside and the outside. The housing 14 can discharge air thereinside to the outside through the exhaust port 140. The housing 14 includes a connection port 141 that communicate between the inside and the outside and allows the heat retaining unit 15 to be connected thereto.

The heat retaining unit 15 is configured to send hot air to the inside of the housing 14 via the connection port 141. Therefore, the melting device 1 can maintain the temperature inside the housing 14 at a specific temperature by the hot air sent into the housing 14 from the heat retaining unit 15 via the connection port 141. Accordingly, the melting device 1 can circulate the melted material through the melting path while maintaining it in the liquid state.

As shown in FIG. 1, the homogenizer 3 includes a reservoir 30 configured to store the liquid material sent out from the melting device 1, and a transport system 31 configured to circulate the liquid material stored in the reservoir 30.

The supply pipe 130c of the melting device 1 is fluidically connected to the reservoir 30.

The transport system 31 includes a transport path 310 fluidically connected to the reservoir 30. The transport system 31 further includes a suction pump 311 configured to send the liquid material stored in the reservoir 30 into the transport path 310.

The transport path 310 includes an inflow pipe 310a through which the liquid material stored in the reservoir 30 flows therein, and a linking pipe 310b fluidically connected to each of the inflow pipe 310a and the reservoir 30. The transport path 310 further includes an outlet pipe 310c fluidically connected to each of the inflow pipe 310a and the outlet device 4.

The transport system 31 according to this embodiment includes an outlet valve 312 that can be switched between the state where the inflow pipe 310a and the linking pipe 310b communicate with each other and the state where the inflow pipe 310a and the outlet pipe 310c communicate with each other.

Therefore, when the outlet valve 312 is switched to the state where the inflow pipe 310a and the linking pipe 310b communicate with each other, the inflow pipe 310a, the linking pipe 310b, and the reservoir 30 communicate with one another, thereby forming a homogenizing path that serves as a circulation path through which the liquid material is circulated in the homogenizer 3. Then, the circulation of the liquid material from the inflow pipe 310a to the outlet pipe 310c (that is, supply of the liquid material to the outlet device 4) is restricted.

Whilst, when the outlet valve 312 is switched to the state where the inflow pipe 310a and the outlet pipe 310c communicate with each other, the circulation of the liquid material from the inflow pipe 310a to the outlet pipe 310c (supply of the liquid material to the outlet device 4) is allowed. Then, the circulation of the liquid material from the inflow pipe 310a to the linking pipe 310b is restricted.

In this embodiment, the processing amount of the material that the homogenizer 3 can homogenize is larger than the processing amount of the material that the melting device 1 can melt. In this embodiment, the processing amount of the material that the homogenizer 3 can homogenize is larger than the processing amount of the material that the melting device 2 can melt. A more specific description will be given. The amount of the liquid material that is circulated through the homogenizing path of the homogenizer 3 is larger than the amount of the liquid material that is circulated through the melting path of the melting device 1.

The outlet device 4 includes a body 40 to which the liquid material is supplied from the transport system 31 of the homogenizer 3, and an outlet 41 through which the liquid material in the body 40 is discharged.

The outlet pipe 310c of the transport path 310 is fluidically connected to the body 40. Therefore, in the outlet device 4, the liquid material supplied from the homogenizer 3 to the body 40 via the outlet pipe 310c is discharged through the outlet 41. A material other than the material supplied from the homogenizer 3 may be supplied to the body 40. That is, a different kind of material may be supplied to the body 40.

The material purification system according to this embodiment is as described above. Subsequently, the operation of the material purification system according to this embodiment will be described with reference to the attached drawings.

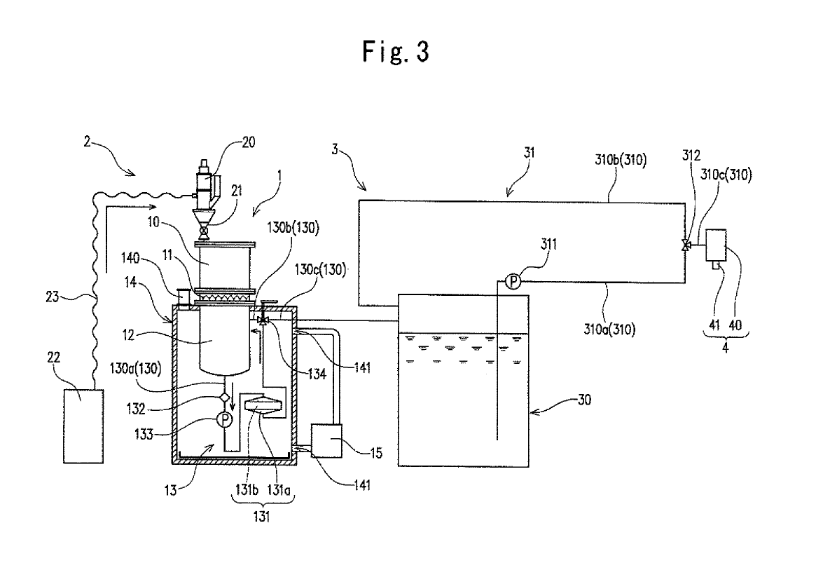

As shown in FIG. 3, for melting the solid material by the melting device 1 according to this embodiment, the solid material is put into the melting device 1 by the inlet device 2.

A more specific description will be given. First, after the on-off valve 21 is closed, the solid material is supplied from the storage tank 22 to the hopper 20 via the pipe member 23. Then, after the on-off valve 21 is opened, and the solid material inside the hopper 20 is put into the inlet 10, the on-off valve 21 is closed.

In this way, in this embodiment, for intermittently putting the solid material from the hopper 20 to the inlet 10, the solid material is stored in the hopper 20 for a while. Thereby, the input amount of the solid material from the hopper 20 into the inlet 10 is made uniform in this embodiment.

Then, the solid material put into the inlet 10 is melted by the melting unit 11. Thereby, the solid material put into the inlet 10 is changed from solid state to liquid state in the melting unit 11, so that the liquid material flows into the storage 12. Then, the liquid material inside the storage 12 is sent out to the delivery pipe 130a by the power of the delivery pump 133, passes through the strainer 132, and thereafter passes through the filter unit 131.

At this time, as the liquid material passes through the filter unit 131, solid matter such as foreign matter contained in the liquid material and unmelted material remains in the filter unit body 131b. Thereby, the liquid material is separated from the solid matter. Further, the unmelted material is exposed to the liquid material while being stayed in the filter unit body 131b so as to be melted by the heat of the liquid material and then passes through the filter unit body 131b.

Further in this embodiment, for melting the solid material by the melting unit 11, the supply valve 134 is switched so that the delivery pipe 130a and the connection pipe 130b communicate with each other. That is, while the melting path is formed by the delivery pipe 130a, the connection pipe 130b, and the storage 12, the solid material is melted by the melting unit 11.

Therefore, the liquid material sent out from the storage 12 to the delivery pipe 130a by the power of the delivery pump 133 passes through the filter unit 131 and thereafter is sent out to the storage 12 via the connection pipe 130b.

Thus, in the melting device 1, the liquid material is circulated through the melting path, and therefore the liquid material passes through the filter unit 131 multiple times. The melting device 1 can therefore allow the solid matter such as foreign matter contained in the liquid material and unmelted material to remain in the filter unit body 131b more reliably.

The unmelted material remaining in the filter unit body 131b is melted more reliably by being continuously exposed to the liquid material circulated through the melting path. Further, in the melting device 1 according to this embodiment, the temperature inside the housing 14 is maintained at a specific temperature by the heat retaining unit 15, and therefore the unmelted material remaining in the filter unit body 131b is further reliably melted by the liquid material circulated through the melting path.

The plurality of filter media 131c of the filter unit body 131b having rougher meshes are arranged at positions closer to the inflow port, as described above. Therefore, the liquid material flows into the holder 131a through the inflow port and thereafter passes through the filter media 131c sequentially from the filter medium 131c having the roughest mesh to flow out of the holder 131a through the outflow port.

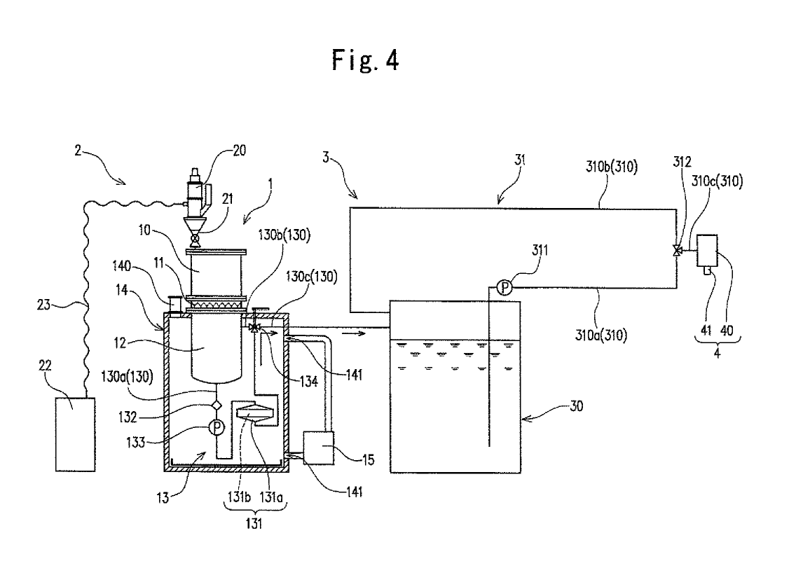

When the supply valve 134 is switched to allow the delivery pipe 130a and the supply pipe 130c to communicate with each other, the liquid material sent out from the storage 12 to the delivery pipe 130a by the power of the delivery pump 133 is sent out to the reservoir 30 of the homogenizer 3 via the supply pipe 130c, as shown in FIG. 4. Thereby, the liquid material is supplied from the melting device 1 to the homogenizer 3.

In this embodiment, for supplying the liquid material from the melting device 1 to the homogenizer 3, the outlet valve 312 is switched to allow the inflow pipe 310a and the linking pipe 310b to communicate with each other. That is, the homogenizing path is formed by the inflow pipe 310a, the linking pipe 310b, and the reservoir 30.

Therefore, the liquid material flowing from the supply pipe 130c into the reservoir 30 is sent out to the inflow pipe 310a by the suction pump 311 and thereafter is sent out to the reservoir 30 through the linking pipe 310b. In this way, the liquid material is circulated through the homogenizing path by the power of the suction pump 311 in the homogenizer 3. Thereby, the liquid material is stirred to be homogenized in the homogenizer 3.

After the liquid material is supplied from the melting device 1 to the homogenizer 3, the solid material is newly supplied from the storage tank 22 to the hopper 20 via the pipe member 23. Then, after the solid material within the hopper 20 is put into the inlet 10 by opening the on-off valve 21 again, the on-off valve 21 is closed.

The solid material that is newly put into the inlet 10 is also melted by the melting unit 11 to be changed from solid state to liquid state and is stored in the storage 12. Then, the liquid material in the storage 12 is sent out to the delivery pipe 130a by the power of the delivery pump 133, passes through the strainer 132, and thereafter passes through the filter unit 131.

In this embodiment, for melting the solid material that is newly put into the inlet 10 by the melting unit 11, the supply valve 134 is switched to allow the delivery pipe 130a and the connection pipe 130b to communicate with each other again. That is, the melting path is formed again by the delivery pipe 130a, the connection pipe 130b, and the storage 12. Therefore, the liquid material sent out from the storage 12 to the delivery pipe 130a by the power of the delivery pump 133 passes through the strainer 132 and the filter unit 131 and thereafter is sent out to the storage 12 through the connection pipe 130b.

Then, when the supply valve 134 is switched to allow the delivery pipe 130a and the supply pipe 130c to communicate with each other, the liquid material sent out by the power of the delivery pump 133 passes through the supply pipe 130c and thereafter is sent out to the reservoir 30 of the homogenizer 3.

As described above, since the processing amount of the material that the homogenizer 3 can homogenize is larger than the processing amount of the material that the melting device 1 can melt, the material melted later is sent out to the reservoir 30 of the homogenizer 3 and then is circulated through the homogenizing path together with the liquid material (the material melted earlier) supplied to the homogenizer 3 earlier. Thereby, the material melted earlier and the material melted later are stirred and mixed together to be homogenized in the homogenizer 3.

When the outlet valve 312 is switched to allow the inflow pipe 310a and the outlet pipe 310c to communicate with each other, the homogenized liquid material is discharged from the outlet 41 as a polishing pad material.

As described above, in the melting device 1 of the material purification system according to this embodiment, the material melted in the melting unit 11 is circulated through the filter unit 131, thereby allowing solid matter such as foreign matter contained in the solid material put into the melting unit 11 and unmelted material to remain in the filter unit body 131b of the filter unit 131. Accordingly, the melting device 1 can separate the solid matter from the liquid material.

The liquid material can be circulated through the melting path in the melting device 1, and therefore the liquid material can be stirred to be homogenized to the molecular level. Further, the liquid material passes through the filter unit 131 multiple times by being circulated through the circulation path in the melting device 1, and therefore the solid matter is separated from the liquid material more reliably.

In this way, the melting device 1 can homogenize the liquid material while reducing the content of solid matter in the liquid material. Thereby, the melting device 1 can stabilize the quality of the liquid material.

The unmelted material remaining in the filter unit body 131b is exposed to the liquid material and therefore is melted by the heat of the liquid material. Accordingly, the melting device 1 can melt the unmelted material remaining in the filter unit body 131b by exposing it to the liquid material, and therefore the solid material put into the inlet 10 can be used as a polishing pad material without waste.

In this embodiment, the temperature inside the housing 14 is maintained at a temperature at which the melted material can be maintained in the liquid state by the heat retaining unit 15, and therefore the unmelted material remaining in the filter unit body 131b can be melted more reliably.

In this embodiment, the plurality of filter media 131c having rougher meshes are arranged at positions closer to the inflow port. Therefore, in the filter unit 131, solid matter is separated from the liquid material while clogging of each filter medium 131c is suppressed.

The melting device 1 according to this embodiment can be switched between the state where the liquid material is circulated through the melting path and the state where the liquid material is sent to the outside by switching the supply valve 134 and therefore can send the liquid material to the outside after completely melting the entire solid material put into the inlet 10.

The homogenizer 3 configured to homogenize the melted material is connected to the melting device 1 according to this embodiment, and therefore the material changed from solid state to liquid state in the melting device 1 is stirred to be homogenized in the homogenizer 3.

The processing amount of the material that the homogenizer 3 can homogenize is larger than the processing amount of the material that the melting device 1 can melt, and therefore both of the material melted earlier and the material melted later can be stirred to be mixed together in the homogenizer 3 by supplying the material melted later to the homogenizer 3 while stirring the material melted earlier in the homogenizer 3. In this way, the material purification system 1 can purify a material so as to have higher homogeneity by making the quality of the material melted earlier and the quality of the material melted later uniform.

The material purification system 1 includes the homogenizing path through which the liquid material is circulated by the homogenizer 3, and therefore the material newly melted by the melting device 1 and the liquid material supplied earlier from the melting device 1 to the homogenizer 3 can be circulated in the homogenizing path to be stirred, after they are mixed together. Accordingly, the homogeneity of the material purified in the material purification system 1 is further enhanced.

The melting device according to the present invention is not limited to the aforementioned embodiment, and it is, of course, that various modifications can be made without departing from the gist of the present invention.

In the aforementioned embodiment, the flow path 130 includes the delivery pipe 130a into which the material stored in the storage 12 flows, the connection pipe 130b fluidically connected to each of the delivery pipe 130a and the storage 12, and the supply pipe 130c fluidically connected to the delivery pipe 130a and the homogenizer 3 (the reservoir 30 of the homogenizer 3, which will be described below), but there is no limitation to this configuration. For example, the flow path 130 may be configured not to include the connection pipe 130b, as long as it allows the liquid material to pass through the filter unit 131.

In the aforementioned embodiment, the melting device 1 supplies the liquid material intermittently to the reservoir 30, but the melting device 1 may supply the liquid material continuously to the reservoir 30.

In the aforementioned embodiment, the case where the solid material is intermittently put into the inlet 10 is described, but there is no limitation to this configuration. For example, the solid material may be melted in the melting unit 11 while the solid material is continuously put into the inlet 10.

In this way, the melting device 1 can allow foreign matter or unmelted material to remain in the filter unit body 131b and further can melt the material remaining in the filter unit body 131b by exposing it to the liquid material, as long as the melting device 1 can pass the liquid material through the filter unit 131, and therefore the method for putting the solid material therein or the method for sending the liquid material to the outside (in this embodiment, the method for supplying the liquid material to the homogenizer 3) is not limited.

In the aforementioned embodiment, the heat retaining unit 15 maintains the temperature inside the housing 14 at a specific temperature by feeding hot air into the housing 14, but there is no limitation to the configuration of feeding hot air into the housing 14, as long as the heat retaining unit 15 can maintain the temperature inside the housing 14 at a specific temperature.

In the aforementioned embodiment, the filter unit body 131b includes the plurality of filter media 131c, but there is no limitation to this configuration. For example, the filter unit body 131b may include a single filter medium 131c. In the case where the filter unit body 131b includes a single filter medium 131c, the single filter medium 131c may be obtained by bonding the plurality of filter media 131c stacked on each other.

In the aforementioned embodiment, the homogenizer 3 configured to homogenize the melted material by stirring is connected to the melting device 1, but there is no limitation to this configuration. For example, the melting device 1 may be configured so that the liquid material is supplied directly to the outlet device 4, or the liquid material is poured into a mold or the like. Therefore, the supply pipe 130c is not limited to a pipe fluidically connected to the reservoir 30 of the homogenizer 3.

### REFERENCE SIGNS LIST

1: Melting device
2: Inlet device
3: Homogenizer
4: Outlet device
10: Inlet
11: Melting unit
12: Storage
13: Circulation system
14: Housing
15: Heat retaining unit
20: Hopper
21: On-off valve
22: Storage tank
23: Pipe member
30: Reservoir
31: Transport system
40: Body
41: Outlet
130: Flow path
130a: Delivery pipe
130b: Connection pipe
130c: Supply pipe
131: Filter unit
131a: Holder
131b: Filter unit body
131c: Filter medium
132: Strainer
133: Delivery pump
134: Supply valve
140: Exhaust port
141: Connection port
310: Transport path
310a: Inflow pipe
310b: Link pipe
310c: Outlet pipe
311: Suction pump
312: Outlet valve

1. A polishing pad material melting device comprising:
a melting unit configured to melt a solid material;
a flow path through which the material melted in the melting unit is circulated; and
a filter unit fluidically connected to the flow path and including a filter unit body configured to filter the material melted in the melting unit, wherein
the flow path includes a circulation path through which the material melted by the melting unit is circulated, and
the filter unit is fluidically connected to the circulation path.

2. The polishing pad material melting device according to claim 1, wherein
the filter unit body includes a plurality of filter media each having a different mesh roughness and stacked on each other, and
the plurality of filter media having rougher meshes are arranged more on the upstream side in the direction in which the melted material flows.
